(19) United States
(12) Patent Application Publication
(10) Pub. No.: US 2007/0094670 A1
(43) Pub. Date: Apr. 26, 2007

(54) Method and an apparatus for providing automatic emergency mode plan generation in a utility computing environment

(76) Inventor: David Andrew Graves, Monte Sereno, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,513

(22) Filed: Oct. 26, 2005

(51) Int. Cl. G06F 9/46

(52) U.S. Cl. 718/104

(57) ABSTRACT

Embodiments of the present invention pertain to providing emergency mode plan generation in a utility computing environment (UCE). In one embodiment, information that describes criticality of applications is received. Information is received that indicates one or more resources assigned for use by one or more of the applications can no longer be used by the applications to which the resources are assigned. A plan is automatically generated that indicates whether resources assigned for use by a first application can be used by a second application instead of the first application based on the criticality of the applications, wherein the one or more resources are managed by a UCE.

### RELATED APPLICATIONS

This Application is related to U.S. patent application Ser. No. 11/047,792 by David Graves, Fredrick Roeling, filed on Jan. 31, 2005 as the present application and entitled “METHOD AND APPARATUS FOR USING AN APPLICATION PROGRAM INTERFACE (API) FOR AUTOMATED CONTROL OF AN INFORMATION TECHNOLOGY RESOUCE FARM IN A UTILITY COMPUTING ENVIRONMENT” with attorney docket no. HP 200404350-1, assigned to the assignee of the present invention and incorporated herein by reference as background material.

### TECHNICAL FIELD

Embodiments of the present invention relate to managing resources. More specifically, embodiments of the present invention relate to emergency mode plan generation in a utility computing environment (UCE).

### BACKGROUND ART

Typically data centers include many different types of resources, such as computational servers, firewalls, load balancers, data backup devices, and arrays of data storage disks. For example, a data center for a hospital may use part of the resources for the operating room and other parts of the resources for the billing department. Applications, such as billing software or surgical monitoring software, may be installed and executed on certain resources, such as computational servers. Data that the applications create and/or use, such as billing data, patient data, or surgical data, may be stored on other resources, such as storage disks.

In the event of a major disaster, a data center can be damaged. For example, a bomb or an earth quake could destroy a building where various resources for a data center reside.

“Disaster recovery” is a term that commonly refers to restoring a data center to the way it was before the disaster occurred. Completely restoring the data center can take weeks, even months. Some large installations have a second data center that can be used in the event that a primary data center is partially or totally destroyed. However, many installations do not have secondary data centers.

Therefore, there is a need to allow a data center to operate more quickly than what is provided by conventional disaster recovery schemes.

### DISCLOSURE OF THE INVENTION

Embodiments of the present invention pertain to providing emergency mode plan generation in a utility computing environment. In one embodiment, information that describes criticality of applications is received. Information is received that indicates one or more resources assigned for use by one or more of the applications can no longer be used by the applications to which the resources are assigned. A plan is automatically generated that indicates whether resources assigned for use by a first application can be used by a second application instead of the first application based on the criticality of the applications, wherein the one or more resources are managed by a UCE.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an emergency mode plan generation, according to embodiments of the present invention.

FIG. 2 is a block diagram of an exemplary software system that uses an emergency mode plan generator, according to embodiments of the present invention.

FIG. 3 is a block diagram of an exemplary farm, according to embodiments of the present invention.

FIG. 4 depicts a flowchart 400 for a method of providing emergency mode plan generation in a utility computing environment, according to embodiments of the present invention.

FIG. 5 depicts a flowchart 500 for logic that an emergency mode plan generator can use for re-assigning resources, according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Software System and Functional Overviews

In contrast to conventional disaster recovery schemes, embodiments of the present invention do not provide for completely restoring a data center to the way it was previous to a disaster. Instead embodiments of the present invention can be used as a “first response” for example to the disaster by re-distributing resources based on the criticality of applications.

As already stated, a data center for a hospital, for example, may use part of the resources associated with the data center for the operating room and other parts of the resources for the billing department. In the event of a disaster, such as an earthquake, parts of the hospital may be damaged. More specifically, the building that includes resources used by the operating room may be destroyed but the building that includes resources used by the billing department may be intact.

According to one embodiment, information that describes the criticality of an application is associated with each application in a data center. For example, criticality of an application can be ranked as “high,” “medium,” or “low.” Continuing the example, a criticality of “high” can be associated with surgical monitoring software, whereas, a criticality of “low” can be associated with billing software. According to another embodiment of the present invention, the criticality of the applications is used to automatically generate a plan that indicates whether resources assigned for use by one application can be used by another application instead. Continuing the example, if the resources assigned to the operating room are destroyed, the resources which are currently assigned to the billing department can be re-assigned (e.g., redeployed) to the operating room. Further, the criticality of the billing software (e.g., “low”) and the surgical monitoring software (e.g., “high”) can be used to automatically generate a plan that indicates that the resources for the billing department are to be re-assigned to the operating room in the event of a disaster. An emergency mode plan generator (EMPG) can be used to automatically generate the plan. According to one embodiment, the generated plan can then be automatically implemented, as will become more evident. Although embodiments of the present invention are described in the context of a data center for a hospital, embodiments for the present invention can be used for any type of data center.

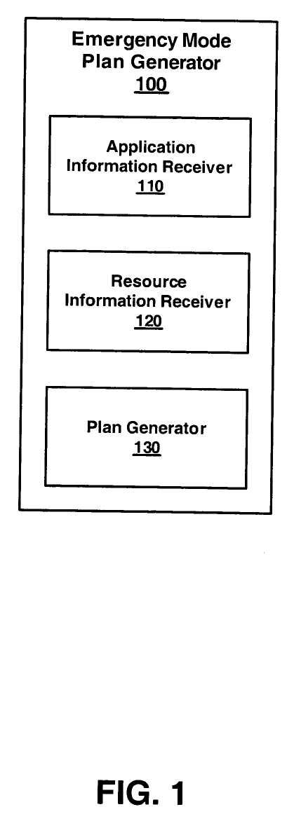

FIG. 1 is a block diagram of an emergency mode plan generation, according to embodiments of the present invention. The blocks in FIG. 1 can be arranged differently than as illustrated, and can implement additional or fewer features than what are described herein. Further, the features represented by the blocks in FIG. 1 can be combined in various ways.

The EMPG 100 includes an application information receiver 110, a resource information receiver 120, and a plan generator 130. The application information receiver 110 receives information that describes criticality of applications. For example, the application information receiver 110 can receive information indicating that the criticality of the billing department is “low” and the criticality of the surgical monitoring software is “high.”

The resource information receiver 120 receives information indicating that one or more resources assigned for use by one or more of the applications can no longer be used by the applications to which the resources are assigned. For example in the event of an earthquake destroying the resources assigned to the operating room, the resource information receiver 120 can receive information indicating that the resources assigned to the operating room are no longer available.

The resource information receiver 120 can receive information indicating that resources assigned for use by certain applications can no longer be used due to the occurrence of a disaster, from several different sources. For example, a person may cause the resource information receiver 120 to receive the information indicating a disaster has occurred by interacting with a user interface associated with the resource information receiver 120, as will be discussed in more detail. In another example, a computer system can communicate with the resource information receiver 120 indicating that a disaster has occurred, as will be discussed in more detail.

The plan generator 130 automatically generates a plan (also referred to herein as an “emergency mode plan”) that indicates whether resources assigned for use by a first application can be used by a second application instead of the first application. Continuing the example, a plan can be generated that indicates that the resources for the billing department are to be assigned to the operating room.

Data centers frequently use one or more UCEs to manage resources. According to one embodiment, an EMPG can be used in the context of a UCE for generating an emergency mode plan.

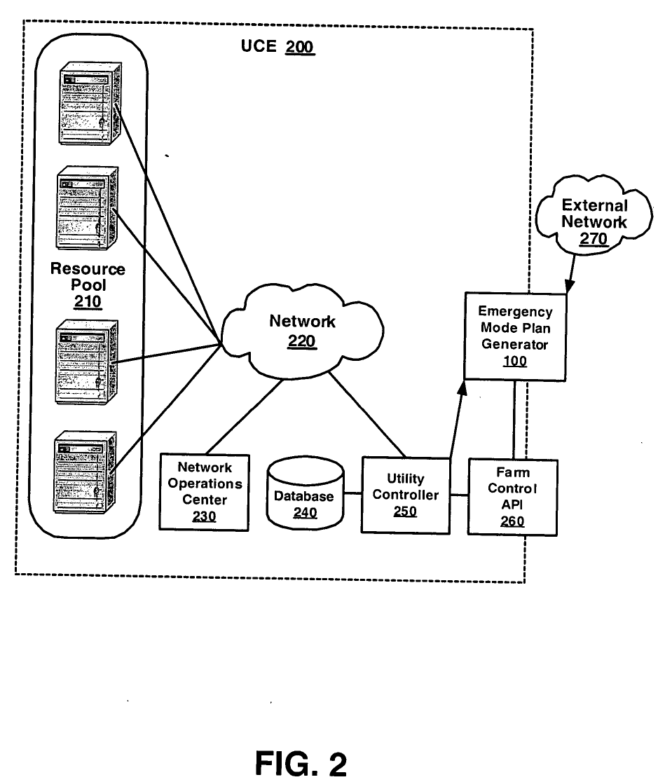

FIG. 2 is a block diagram of an exemplary software system that uses an emergency mode plan generator, according to embodiments of the present invention. The blocks that represent features in FIG. 2 can be arranged differently than as illustrated, and can implement additional or fewer features than what are described herein. Further, the features represented by the blocks in FIG. 2 can be combined in various ways.

As depicted in FIG. 2, the exemplary software system includes a utility computing environment 200, an external network 270, an EMPG 100 that is on the edge of the UCE 200, and a farm control application program interface 260 (API) that is also on the edge of the UCE 200. The UCE 200 also includes a pool of resources 210, a network operations center 230 (NOC), a database 240, a utility controller 250 (UC) and a network 220. The network 220 couples the resources 210, the NOC 230 and the UC 250 together. The database 240 and the UC 250 can communicate, the UC 250 can communicate with the EMPG 100 and the Farm Control API 260. The EMPG 100 and the farm control API 260 can communicate with each other. The external network 270 can communicate with the EMPG 100.

The resources 210 can be computational servers, firewalls, load balancers, data backup devices, and arrays of data storage disks, among other things. A “farm” can be created from one or more of the resources 210, as will be explained in more detail. One or more of computational devices can be automatically deployed from the pool of resources 210 to create a farm. The resources 210 associated with a farm are typically networked together using a network map, as will become more evident. The database 240 is machine-readable and contains information describing the resources 210 and the attributes of the resources 210 that are associated with “farms,” according to one embodiment The UC 250 is a system that uses a network map as a specification to create “farms” by automatically configuring and deploying resources from the pool of resources 210, according to one embodiment. One or more data center administrators (DCAs), for example, can use the NOC 230 to operate the UCE 200. The DCAs can use a portal (not shown) to submit requests to the UC 250 or to update information associated with the database 240.

The farm control API 260 allows external computer programs (not shown) to perform operations on the farms. The EMPG 100 is capable of making decisions to automatically reallocate the resources 210 to support critical applications following a disastrous event, according to one embodiment.

The exemplary software system also includes a library of backup media (not shown) and a user interface (not shown) that allows a DCA to update designs of farms with attributes, according to one embodiment. Examples of the attributes are the criticality of an application and a minimum quantity of resources 210 that an application needs in order to execute. The designs of the farms can be stored in the database 240. The library of backup media can contain regularly updated applications and data from remote UCEs 200. The remote UCEs 200 can use an external network 270 to communicate with the EMPG 100.

### Resources

The resources 210 can be any component that is hardware, software, firmware, or combination thereof that can be used by a data center to provide services. For example, the resources 210 can be computational servers, firewalls, load balancers, data backup devices, and arrays of data storage disks among other things.

### Farms and Farm Designs

A “farm” can be created from one or more of the resources 210. For example, one or more computational servers can be automatically deployed from the pool of resources 210 associated with a UCE 200 to create a farm. The resources 210 associated with a farm are typically networked together using a network map.

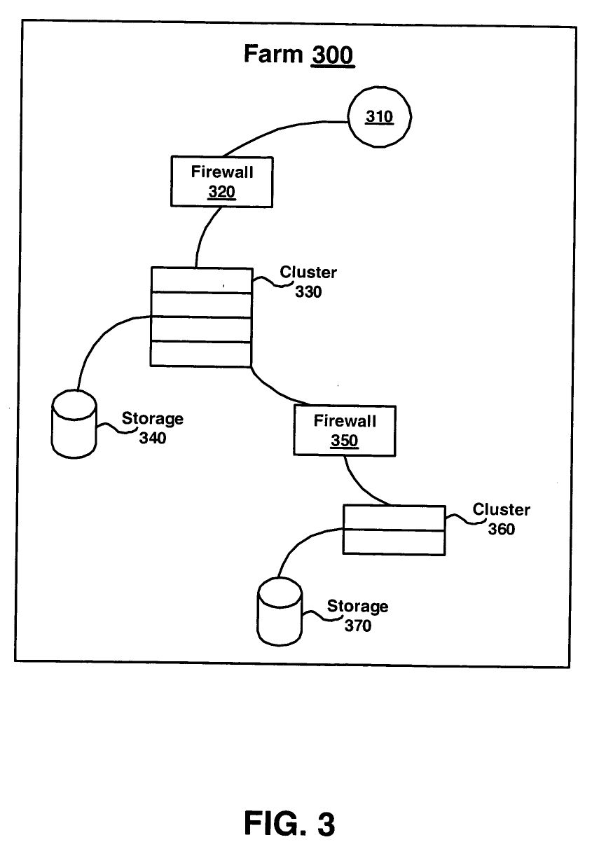

FIG. 3 is a block diagram of an exemplary farm, according to embodiment of the present invention. The blocks in FIG. 3 can be arranged differently than as illustrated, and can implement additional or fewer features than what are described herein. Further, the features represented by the blocks in FIG. 3 can be combined in various ways.

As depicted in FIG. 3, the farm 300 includes various resources, such as a backbone 310, two firewalls 320, 350, two clusters of servers 330, 360, and two storage devices 340, 370. Applications can be installed and executed on the clusters of servers 330, 360. Data that the applications create and/or use can be stored on the storage devices 340, 360. The firewalls 320, 350 can be used for protecting the applications on clusters 330, 360 and the data on storage devices 340, 370. The backbone 310 allows the farm 300 to communicate with the rest of the resources associated with a data center.

A farm design can be depicted with a schematic, such as that depicted in FIG. 3. A farm design depicts what resources 310, 320, 330, 340, 350, 360, 370 are associated with the farm 300 and how the resources 310, 320, 330, 340, 350, 360, 370 are connected, among other things

### Criticality Of Applications and Criticality of Farms

Any means of indicating the criticality of an application and/or a farm can be used. For example, a description of criticality such as “high,” “medium,”“low” could be used or a number, such as 1 to 100, that indicates the relative ranking of an application's and/or farm's criticality could be used. In this later example, 1 may indicate the lowest level of criticality whereas 100 may indicate the highest level of criticality, or vice versa.

Personnel, such as a DCA, can enter information that describes the criticality of applications and/or farms and the application information receiver 110 associated with an EMPG 100 will receive the information. For example, the application information receiver 110 can receive information indicating that the billing software has a “low” criticality and the operating room monitoring software has a “high” criticality. According to one embodiment, the information that indicates the criticality of applications and/or farms is stored in a database 240 (FIG. 2).

Security documentations, such as the National Security Agency (NSA) INFOSEC Assessment Methodology (IAM), can be used to help DCAs determine the criticality of applications and/or farms.

Since applications are installed and executed on servers that are associated with farms, the criticality of applications can be used for determining the criticality of farms that those applications are associated with, according to one embodiment. Similarly, the criticality of farms can be used for determining the criticality of applications associated with those farms, according to another embodiment.

A user interface can be used for entering the criticality of applications and/or farms. For example, personnel associated with the UCE 200 can enter the criticalities into the user interface and the criticalities can be received by the application information receiver 110.

### Minimum Quantity

According to another embodiment, the minimum number (e.g., minimum quantity) of resources 210 that an application needs to operate is used as a part of generating the emergency mode plan. More specifically, if a farm has 4 servers but can operate with only 1 server (e.g., minimum quantity is 1), then the plan can indicate that the remaining 3 servers can be “freed up” and reassigned to an application associated with another farm. Continuing the example, if a farm with “medium” criticality, such as a farm used by an emergency room has 4 servers but can operate with only 1 server, then the plan can indicate that the remaining 3 servers can be reassigned to another farm, such as a farm used for billing software (with “low” criticality) or surgery monitoring software (with “high” criticality), in the event of a disaster.

According to one embodiment, the minimum quantity of resources 210 that an application needs in order to operate is stored in a database 240 (FIG. 2), according to one embodiment. A minimum quantity is associated with each resource associated with a farm design, according to one embodiment.

According to another embodiment, the minimum quantity can be applied to each cluster associated with a farm. For example, referring to FIG. 3, the farm has two clusters. As depicted in FIG. 3, four servers are associated with cluster 330 and two servers are associated with cluster 360. For example, assuming that a minimum quantity of 2 was associated with cluster 330, and a minimum quantity of 1 was associated with cluster 360, then 2 servers would be freed up from cluster 330 and 1 server would be freed up from cluster 360.

A user interface can be used for entering the criticality of applications and/or farms. For example, personnel associated with the UCE 200 can enter the criticalities into a user interface and the criticalities can be received by the EMPG 100.

### Resource Information Receiver

According to one embodiment, the resource information receiver 120 receives information indicating that one or more resources 210 assigned for use by one or more applications can no longer be used by the applications to which the resources 210 are assigned. Continuing the example, the resource information receiver 120 could receive information indicating that the operating room can no longer use the resources 210 that were assigned to the operating room because the building that the resources 210 are kept in has been destroyed.

The resource information receiver 120 can receive the information in a number of ways. According to one embodiment, the information receiver receives the information automatically from a computer system. For example, a UCE 200 may detect a massive failure within itself and then notify the EMPG 100 that is associated with the UCE 200. In another example, another UCE may detect a failure and communicate with the EMPG 100 associated with the UCE 200. In this case, the other UCE may be able to communicate with the EMPG 100 over an external network 270.

In another embodiment, the resource information receiver 120 receives the information from a user interface. For example, personnel associated with the NOC 230 may realize that a disaster has occurred where resources 210 associated with one or more UCEs 200 have been disabled or destroyed. The personnel can use the portal to indicate that a disaster has occurred. The database 240 can be updated to indicate that resources 210 have been lost. A request to generate a plan can be submitted to the EMPG 100, according to one embodiment. The plan can be used to redeploy resources 210, according to another embodiment.

### The Plan

The plan indicates whether resources 210 assigned for use by one application can be used instead by another application, according to one embodiment. The criticality of applications is used as a part of generating the plan, according to one embodiment. For example, the plan can indicate that resources 210 assigned to an application with a relatively lower criticality should be reassigned to an application with a relatively higher criticality in the event of a disaster.

The minimum quantity can also be used as a part of generating the plan, according to another embodiment. For example, if a farm has 4 servers but can operate with only 1 server (e.g., minimum quantity is 1), then the plan can indicate that the remaining 3 servers can be reassigned to an application associated with another farm. Continuing the example, if a farm with “medium” criticality, such as a farm used by an emergency room has 4 servers but can operate with only 1 server, then the plan can indicate that the remaining 3 servers can be reassigned to another farm, such as a farm used for billing software (with “low” criticality) or surgery monitoring software (with “high” criticality), in the event of a disaster.

The plan is used automatically without any amendments, according to one embodiment. According to another embodiment, the plan is approved, and possible amended, for example, by a DCA. For example, the default option could be to require that the plan be reviewed by a DCA which could then approve the plan without amendment or amend the plan and then approve the amended plan. The DCA may amend the plan by approving redeployment of some farms in the plan, while denying permission to redeploy other farms, since, for example, the DCA may have knowledge about application needs outside the context of the database 240.

However, the default option could be overridden to allow the plan to be used without any approval by the DCA or any amendments. For example, the system may wait a certain period of time for a DCA to approve and possible amend the plan. If a DCA does not approve the plan within the period of time, then the plan can be used to reassign resources 210 from one application to another application. Putting the plan into use with out requiring approval can be useful in the event that all personal are incapacitated. The EMPG 100 can prompt a DCA, for example, via a user interface to approve and possible amend the plan, the default option was previously overriden.

### OPERATIONAL EXAMPLE

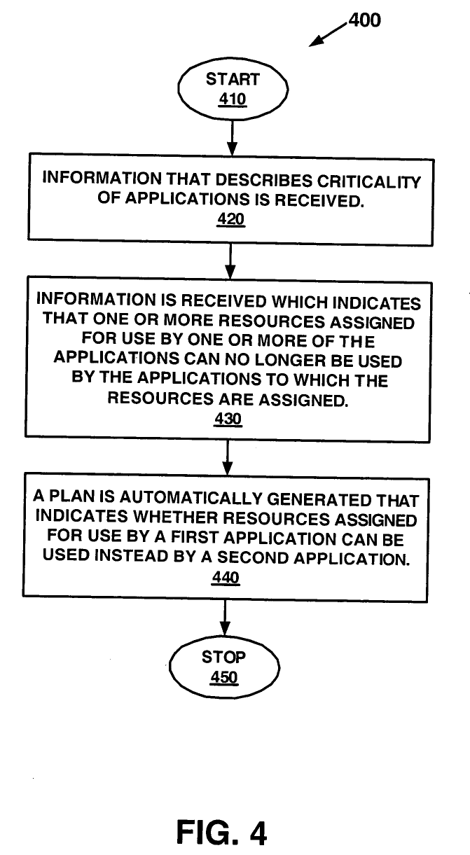

FIG. 4 depicts a flowchart 400 for a method of providing emergency mode plan generation in a utility computing environment, according to embodiments of the present invention. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in flowchart 400 may be performed. All of, or a portion of, the embodiments described by flowchart 400 can be implemented using computer-readable readable and computer-executable instructions which reside, for example, in computer-usable media of a computer system or like device.

As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

In step 410, the method starts.

In step 420, information that describes criticality of applications is received. For example, the application information receiver 110 can receive information indicating that the criticality of the billing department is “low,” the criticality of software used by an emergency room is “medium,” and the criticality of the surgical monitoring software is “high.” More specifically, prior to any disaster, authorized personnel, such as a DCA, can use a user interface associated with the NOC 230 to enter information the information that describes the criticality of the billing department, the emergency room, and the surgical monitoring software. The application information receiver 110 can receive the entered information and cause the information to be stored in the database 240. The criticality of the farms can also be entered and received by the application information receiver 110 or automatically computed based on the criticality of the applications. Personnel associated with the NOC 230 can periodically validate the criticality associated with the farms and/or the applications associated the farms, based on a documentation produced by an accepted methodology, such as but not limited to, the National Security Agency (NSA) INFOSEC Assessment Methodology (IAM). This assures readiness prior to a disastrous event.

In step 430, information is received which indicates that one or more resources assigned for use by one or more of the applications can no longer be used by the applications to which the resources are assigned. Continuing the example, in the event of an earthquake destroying the resources 210 used by the operating room, the resource information receiver 120 can receive information indicating that the resources 210 used by the operating room are no longer available.

The resource information receiver 120 can receive the information in a number of ways. According to one embodiment, the information receiver receives the information from a computer system. For example, a UCE 200 may detect a massive failure within itself and then notify the EMPG 100 that it 200 is associated with. In another example, another UCE may detect a failure and notify the EMPG 100 associated with the UCE 200. In this case, the other UCE may be able to communicate with the EMPG 100 over an external network 270.

In another embodiment, the resource information receiver 120 receives the information from a user interface. For example, personnel associated with the NOC 230 may realize that one or more UCEs 200 have been disabled or destroyed. The personnel can use the portal to enter information indicating that one or more resources 210 associated with the operating room are no longer available. The resource information receiver 120 can receive the entered information and cause the database 240 to store the information. The resource information receiver 120 can submit a request to the plan generator 130 to generate a plan.

A more detailed example of step 430 follows, according to another embodiment. The EMPG 100 can send queries to the UC 250 via the farm control API 260 to build a list of all applications currently running on the UCE 200 and of all critical applications that had been running in the UCE 200 (referred to herein as an “application list”). The EMPG 100 can use the “application list” returned by the UC 250 to create a “farm list.” The “farm list” can be sorted by the criticality of the applications associated with each of the farms in the “farm list.”

The EMPG 100 can send queries to the farm control API 260 requesting information about all of the resources 210, such as computational servers, that are currently not assigned to any application (e.g., not deployed and therefore free) in the UCE 200. The EMPG 100 can use the information returned by the farm control API 260 to create a “resource list.” The “resource list” can include information describing all resources 210 both unassigned and currently assigned after the disaster to existing farms.

In step 440, a plan is automatically generated that indicates whether resources assigned for use by a first application can be used by a second application instead of the first application based on the criticality of the applications. For example, if the UCE 200 determines that enough resources 210 are available for deployment to the critical applications that have lost resources 210 without freeing up resources 210 from other applications, then the plan will indicate that the available resources 210 will be deployed to the critical applications.

Alternatively, the plan generator 130 generates a plan that indicates whether resources 210 assigned for use by a first application can be used by a second application instead of the first application. Continuing the example, a plan can be generated indicating that the resources 210 for the billing department are to be re-assigned to the operating room. Further, the plan can be generated based on the minimum quantity associated with applications. Continuing the example, a minimum quantity could associated with an application used by the emergency room. Resources 210 associated with the application, which exceed the minimum quantity, could be freed up.

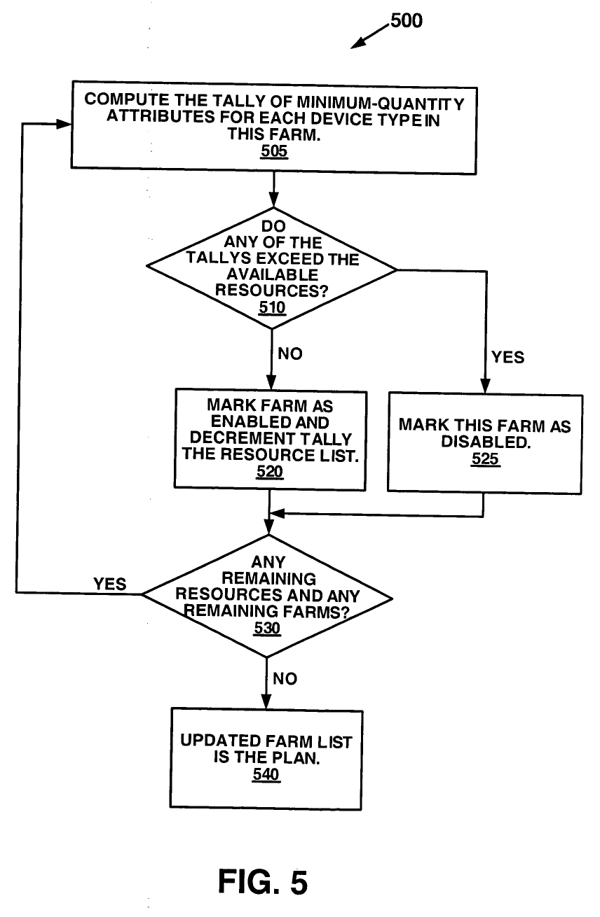

According to another embodiment, a more detailed example of step 440 follows. FIG. 5 depicts a flowchart of logic that an emergency mode plan generator 130 can use for re-assigning resources, according to embodiments of the present invention. The logic depicted in flowchart 5 forms a loop that processes the farms associated with the “farm list” one farm at a time. The farm that is currently being processed shall be referred to as farm “i”.

In step 505, a tally of the minimum-quantity-attributes is computed for each device type in this farm “i”.

In step 510, if any of the tallys exceed the available resources, then proceed to step 525. Otherwise proceed to step 520.

In step 525, mark this farm “i” as “disabled” in the “farm list,” and proceed to step 530.

In step 520, mark this farm “i” as “enabled” in the “farm list,” and decrement the tallys from the “resource list.” The type of hardware, the type of software, and the number of devices associated with a resource, among other things, can be used in determining whether resources 210 are compatible, according to one embodiment. The processing proceeds from step 520 to step 530.

In step 530, if any resources remain in the “resource list,” and if there are any remaining farms in the “farm list,” then proceed to the next farm (e.g., increment “i” for example) on the “farm list,” and proceed back to step 505. Otherwise, proceed to step 540.

In step 540, according to one embodiment, the “farm list,” updated with “enabled” and “disabled” notations, constitutes the plan for re-assigning resources from less critical applications to more critical applications. The farms associated with less critical applications are marked as “disabled” and the farms associated with more critical applications are marked as “enabled,” according to one embodiment.

In step 450, the method described by flowchart 400 stops.

The plan can be used without any amendments, according to one embodiment already described herein. According to another embodiment, the plan is approved, and possible amended, for example, by a DCA, as already described herein.

As already stated, according to one embodiment, the generated plan can then be automatically implemented, as will become more evident. For example, the EMPG 100 can issue commands to the Farm control API 260, to send requests to the UC 250 to automatically implement the plan for freeing resources 210, according to one embodiment. More specifically, farms, and associated applications, that are marked in the plan as “disabled” can be suspended, thus causing the farm's resources 210 to be freed, according to one embodiment. Further, farms that are marked in the plan as “enabled” and which are already running can be reconfigured (resources 210 freed up) based on the minimum quantity associated with the farm, according to embodiments described herein.

The EMPG 100 can issue commands to the Farm control API 260 to send requests to the UC 250 to track the availability of resources 210 previously freed. The EMPG 100 can wait and continue to monitor the availability of resources 210 for the purpose of re-assigning the resources 210 to critical applications.

As sufficient resources 210 become available, the EMPG 100 can issue commands to activate farms that are marked as “enabled” in the plan and which are not already running. The UC 250 can automatically allocate and configure the resources 210, such as computational servers, to create farms.

In the case where storage devices were damaged, personnel associated with the NOC 230 can use the backup media to reload the application and data that the applications created and/or used previous to the disaster. Restoration of backup media can be automated by the UC 250.

After the critical applications have come on-line, the personnel associated with the NOC 230 can continue to monitor the availability of the applications until the state of disaster is declared to be under control.

### CONCLUSION

Prior utility computing environments employed automation for the detection and replacement of failed resources from a pool of unassigned resources. Using resources from a pool of unassigned resources to replace failed resources is commonly called “automated fail-over” or “automated replacement.” However, “automated fail-over” only works if there is a pool of unassigned devices available to replace the failed devices. In contrast, embodiments of the present invention provides automated reallocation of resources to the most critical applications, even when no unassigned devices are available due to a disastrous event.

Existing information security methodologies include the INFOSEC Assessment Methodology (IAM) developed by the National Security Agency (NSA). These existing methodologies define the steps for performing a security assessment, resulting in a report in paper or electronic form, which documents an organizations information assets, and defines the degree of criticality of information assets. This report can subsequently be used to make decisions during a disaster situation. However, deciding on appropriate corrective action depends on the administrator being able to properly interpret the report during the disastrous event, and then manually performing the steps in the report. Under stressful conditions, performing the many manual steps described in the report is prone to error.

Prior solutions include “Disaster Recovery Planning” which is well known in the art. Embodiments of the present invention do not replace disaster recovery planning. Instead, embodiments of the present invention can be used in conjunction with disaster recovery planning. For example, in the prior art, disaster recovery is defined as a process by which a data center is restored to full operation. Thus, the disaster recovery plan is quite complete, but can not account for every possible combination of resource loss, and therefore the disaster recover plan provides only high-level guidance for the restoration of resources. In contrast, embodiments of the present invention provides, among other things, a rapid “first response” to a disaster, by re-assigning limited resources the most critical applications. After the initial disaster has passed, and as more resources become available, the emergency mode plan generated using embodiments of the present invention could be replaced by steps documented in the organization's disaster recovery plan. Thus, embodiments of the present invention are useful as the earlier part of a larger disaster recovery effort, which would ultimately result in full recovery of information processing capabilities.

Prior solutions use manual procedures by technicians physically connecting devices according to a design plan for a farm, and installing software on the servers associated with the farm by hand. Each time a modification to the farm is required, a technician must manually connect or disconnect resources associated with the farm to perform the modification. In contrast, embodiments of the present invention can be performed automatically. For the purposes of this application, “automatic” shall be interpreted to mean without requiring a human to manually generate the emergency mode plan and/or without requiring a human to manually perform operations described by the emergency mode plan.

According to embodiments of the present invention, execution of emergency mode tasks can be automated, with or without guidance by the data center administrator. The automation could proceed rapidly and smoothly in a situation in which it would be very difficult for live personnel to make rational, cool-headed decisions.

Many tasks that formerly required complex thinking and action by the data center personnel can be automatically performed by the EMPG 100, according to embodiments of the present invention. For example, these tasks include:
(a) the assessment of which applications should receive the limited resources,
(b) the implementation of a plan to redeploy limited resources to the more critical applications,
(c) the generation of a plan for freeing up resources from less critical applications, and/or
(d) the generation of a plan for reducing the resources associated with an application to the minimum quantity required by the application in order to operate, thus, making the best use of available resources.

By automating these complex tasks listed above, the following problems are solved, according to embodiments of the present invention:
(a) the reduction if not the elimination of human error during a disaster,
the generation and use of a plan can be accomplished much more quickly than the implementation of a conventional disaster recovery, and/or
(c) the automation of the emergency mode plan. For example, personnel may not be available in some disaster situations. According to embodiments of the present invention, the emergency mode plan can be generated and used automatically, thus, not requiring human intervention.

Any attributes, such as criticality or minimum quantity, that are associated with an application can also be associated with a device in a farm that the application executes on and vice versa. Therefore for the purposes of the claims, if an attribute, such as criticality or minimum quantity, is associated with an application, the attribute shall be interpreted as being associated with the farm that the application executes on. Similarly, for the purpose of the claims, if an attribute, such as criticality or minimum quantity, is associated with a farm, the attribute shall be interpreted as being associated with the application that executes on that farm.

What is claimed is:

1. A method of providing emergency mode plan generation in a utility computing environment, the method comprising:
receiving information that describes criticality of applications;
receiving information indicating that one or more resources assigned for use by one or more of the applications can no longer be used by the applications to which the resources are assigned; and
automatically generating a plan that indicates whether first resources assigned for use by a first application can be used by a second application instead of the first application based on the criticality of the applications, wherein the one or more resources are managed by the utility computing environment (UCE).

2. The method as recited by claim 1, wherein:
the receiving of the information that describes the criticality of the applications further comprises receiving information that indicates that the second application is more critical then the first application; and
the generating the plan further comprises generating a plan that indicates the first resources associated with the first application are to be re-assigned from the first application to the second application.

3. The method as recited by claim 1, wherein:
the receiving of the information indicating that one or more resources assigned for use by one or more of the applications can no longer be used by the applications to which the resources are assigned further comprises receiving the information from a computer system; and
the method further comprises automatically reassigning the first resources that are assigned for use by the first application to the second application based on the plan.

4. The method as recited by claim 3, wherein:
the receiving of the information from the computer system further comprises receiving the information from an external network.

5. The method as recited by claim 3, wherein:
the receiving of the information from a computer system further comprises receiving the information from the utility computing environment.

6. The method as recited by claim 1, wherein:
the receiving of the information indicating that one or more resources assigned for use by one or more of the applications can no longer be used by the applications to which the resources are assigned further comprises receiving the information from a user interface.

7. The method as recited in claim 1, wherein the generating of the plan further comprises:
generating the plan based on a minimum quantity of resources that the applications need to operate.

8. An apparatus for providing emergency mode plan generation in a utility computing environment, the apparatus comprising:
an application information receiver for receiving information that describes criticality of applications;
a resource information receiver for receiving information indicating that one or more resources assigned for use by one or more of the applications can no longer be used by the applications to which the resources are assigned; and
a plan generator for automatically generating a plan that indicates whether first resources assigned for use by a first application can be used by a second application instead of the first application based on the criticality of the applications, wherein the one or more resources are managed by a utility computing environment (UCE).

9. The apparatus of claim 8, wherein:
the application information receiver receives information that indicates the second application is more critical then the first application; and
the plan generator generates a plan that indicates the first resources associated with the first application are to be re-assigned from the first application to the second application.

10. The apparatus of claim 8, wherein:
the resource information receiver receives the information from a computer system; and
the apparatus automatically reassigns the first resources from the first application to the second application based on the plan.

11. The apparatus of claim 10, wherein the utility computing environment is a first utility computing environment and the computer system is a second utility computing environment that communicates with the resource information receiver over an external network.

12. The apparatus of claim 10, wherein the computer system is the utility computing environment.

13. The apparatus of claim 8, wherein:
the resource information receiver receives the information from a user interface.

14. The apparatus of claim 8, wherein the plan generator generates the plan based on a minimum quantity of resources that the applications need to operate.

15. A computer-usable medium having computer-readable program code embodied therein for causing a computer system to perform a method of providing emergency mode plan generation in a utility computing environment, the method comprising:
receiving information that describes criticality of applications;
receiving information indicating that one or more resources assigned for use by one or more of the applications can no longer be used by the applications to which the resources are assigned; and
automatically generating a plan that indicates whether first resources assigned for use by a first application can be used by a second application instead of the first application based on the criticality of the applications, wherein the one or more resources are managed by the utility computing environment (UCE).

16. The computer-usable medium of claim 15, wherein the computer-readable program code embodied therein causes a computer system to perform the method, and wherein:
the receiving of the information that describes the criticality of the applications further comprises receiving information that indicates that the second application is more critical then the first application; and
the generating the plan further comprises generating a plan that indicates the first resources associated with the first application are to be reassigned from the first application to the second application.

17. The computer-usable medium of claim 15, wherein the computer-readable program code embodied therein causes a computer system to perform the method, and wherein:
the receiving of the information indicating that one or more resources assigned for use by one or more of the applications can no longer be used by the applications to which the resources are assigned further comprises receiving the information from a computer system; and
the method further comprises automatically reassigning the first resources that are assigned for use by the first application to the second application based on the plan.

18. The computer-usable medium of claim 17, wherein the computer-readable program code embodied therein causes a computer system to perform the method, and wherein:
the receiving of the information from the computer system further comprises receiving the information from an external network.

19. The computer-usable medium of claim 17, wherein the computer-readable program code embodied therein causes a computer system to perform the method, and wherein:
the receiving of the information from a computer system further comprises receiving the information from the utility computing environment.

20. The computer-usable medium of claim 15, wherein the computer-readable program code embodied therein causes a computer system to perform the method, and wherein:
the generating of the plan further comprises generating the plan based on a minimum quantity of resources that the applications need to operate.

21. A data center comprising:
a plurality of information technology (IT) resources and connections coupled with said plurality of IT resources; with each of said plurality of IT resources represented in a machine-readable map;
an application information receiver for receiving information that describes criticality of applications;
a resource information receiver for receiving information indicating that one or more resources assigned for use by one or more of the applications can no longer be used by the applications to which the resources are assigned; and
a plan generator for generating a plan that indicates whether first resources assigned for use by a first application can be used by a second application instead of the first application based on the criticality of the applications, wherein the one or more resources are managed by a utility computing environment (UCE).
